(19) United States
(12) Patent Application Publication
(10) Pub. No.: US 2013/0147387 A1
(43) Pub. Date: Jun. 13, 2013

(54) Systems and Methods of LED Dimmer Compatibility

(71) Applicant: Matthew Thomas Murdock, Nashua, NH (US)

(72) Inventor: Matthew Thomas Murdock, Nashua, NH (US)

(73) Assignee: Texas Instruments Incorporated, Dallas, TX (US)

(21) Appl. No.: 13/314,168

(22) Filed: Dec. 7, 2011

(51) Int. Cl. H05B 37/02

(52) U.S. Cl. 315/247

(57) ABSTRACT

Systems and methods of LED dimmer compatibility offer LED systems that fit in applications regardless of whether a dimmer is present or the type of dimmer switch that is used. These systems and methods provide high power factor without wasting energy. There are at least three types of wave forms that the LED device may see. The compatibility circuit may be integrated into the LED device such that the device may be screwed into any existing light socket. The device may be usable in a socket whether or not a dimmer is on the line. If a dimmer is present, it may be a trailing edge dimmer or leading edge dimmer. If no dimmer is present on the line, the LED illumination device receives a direct AC line input. The switching of the output transistor of the PFC stage is intelligently applied based on the type of dimmer present.

### TECHNICAL FIELD

The present disclosure is generally related to electronics and, more particularly, is related to dimmer switches.

### BACKGROUND

A dimmer switch is a useful electrical component that allows a user to adjust light levels from nearly dark to fully lit by simply turning a knob or sliding a lever. Early dimmer switches had a pretty straightforward solution to adjusting light levels—a variable resistor. With the variable resistor, the total resistance of the resistor is adjusted by adjusting the distance that the charge has to travel through a resistive material. As the charge works to move through the resistor, energy is lost in the form of heat. A resistor in a series circuit causes a voltage drop in the circuit, decreasing the energy available to other loads (the light bulb, for example). Decreased voltage across the light bulb reduces its light output.

A problem with this solution is that a large amount of energy is lost to heat the resistor, which doesn't help light up the room but still costs in energy consumption. In addition to be being inefficient, these switches tend to be cumbersome and potentially dangerous, since the variable resistor releases a substantial amount of heat.

Instead of diverting energy from the light bulb into a resistor, modern dimmer switches rapidly shut the light circuit off and on to reduce the total amount of energy flowing through the circuit. The light bulb circuit is switched off many times every second. The switching cycle is built around the fluctuation of alternating current (AC). AC current has varying voltage polarity—in an undulating sine wave, it fluctuates from a positive voltage to a negative voltage. A modern dimmer switch automatically shuts the light bulb circuit off every time the current reverses direction—that is, whenever there is zero current running through the circuit. This happens twice per cycle, or 120 times a second. It turns the light circuit back on when the voltage climbs back up to a certain level.

This “turn-on value” is based on the position of the dimmer switch's knob or slider. If the dimmer is turned to a brighter setting, it will switch on very quickly after cutting off. The circuit is turned on for most of the cycle, so it supplies more energy per second to the light bulb. If the dimmer is set for lower light, it will wait until later in the cycle to turn back on. The central element in this switching circuit is a triode alternating current switch, or triac.

A triac is a small semiconductor device, similar to a diode or transistor. The triac has two terminals wired into two ends of the circuit and a third gate terminal used to trigger conduction. There is always a voltage difference between the two terminals, but it changes with the fluctuation of the alternating current. That is, when current moves one way, a first terminal is positively charged while the second terminal is negatively charged, and when the current moves the other way the first terminal is negatively charged while the second terminal is positively charged.

The gate is also wired into the circuit, by way of a variable resistor. This variable resistor works the same basic way as the variable resistor in the older dimmer switch design, but it doesn't waste nearly as much energy generating heat. The triac acts as a voltage-driven switch with the voltage on the gate controlling the switching action and the variable resistor controls the voltage on the gate.

When there is “normal” voltage across the terminals and little voltage on the gate, the triac will act as an open switch—it will not conduct electricity. Once a sufficient voltage is applied to the gate, it begins to conduct electricity. Triacs have a minimum “holding current” that is required for it to remain in conduction. If this holding current is not met the triac will turn off regardless of what voltage is presented across the dimmer or the load. If this holding current is not met during a typical AC period, the triac can “trigger” repeatedly creating undesired operation such as multiple on/off cycles.

The exact sequence varies depending on the direction of the current—that is, which part of the AC cycle is present across the triac. Using the triac with different light sources such as light emitting diodes (LEDs) introduces heretofore unaddressed needs with previous solutions.

### SUMMARY

Example embodiments of the present disclosure provide systems of systems and methods of LED dimmer compatibility. Briefly described, in architecture, one example embodiment of the system, among others, can be implemented as follows: at least one LED; and a power factor correction (PFC) controller connected between the LED illumination device and an AC input to the LED illumination device, the PFC controller configured to: determine whether the LED illumination device receives the AC input from a direct AC line, a trailing edge dimmer, or a leading edge dimmer; and control a gate transistor connected to the LED illumination device based on the determination.

Embodiments of the present disclosure can also be viewed as providing methods for systems and methods of LED dimmer compatibility. In this regard, one embodiment of such a method, among others, can be broadly summarized by the following steps: determining whether the LED illumination device receives an AC input from a direct AC line, a trailing edge dimmer, or a leading edge dimmer; and controlling a gate transistor of a power factor correction (PFC) circuit connected to the LED illumination device based on the determination.

### BRIEF DESCRIPTION OF THE DRAWINGS

FIG. 1 is a circuit diagram of an example embodiment of a wall dimmer with an incandescent light bulb.

FIG. 2 is a circuit diagram of an example embodiment of a trailing edge dimmer with an incandescent light bulb.

FIG. 3 is a signal diagram of an example embodiment of the voltage and current curves of the trailing edge dimmer of FIG. 2.

FIG. 4 is a signal diagram of an example embodiment of the phase angle used to control the dimming in a leading edge dimmer.

FIG. 5 is a signal diagram of an example embodiment of the phase angle used to control the dimming in a trailing edge dimmer.

FIG. 6 is a circuit diagram of an example embodiment of a boost power factor controller circuit.

FIG. 7 is a circuit diagram of an example embodiment of the boost power factor controller circuit of FIG. 6 in connection with a dimmer switch.

FIG. 8 is a circuit diagram of an example embodiment of the boost power factor controller circuit of FIG. 7 with an intelligent PFC controller.

FIG. 9 is a signal diagram of an example embodiment of various dimmer outputs and the switch control signals of the circuit of FIG. 8.

FIG. 10 is a flow diagram of an example embodiment of a method of LED dimmer compatibility.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Turning a dimmer switch knob pivots a contact arm (or contact plate) on a variable resistor, increasing or decreasing its total resistance. When the knob is set to “dim,” the variable resistor offers greater resistance so it “holds up” the current. As a result, the necessary boost voltage doesn't build up as quickly on the firing capacitor. By the time the capacitor is charged enough to make the triac conductive, the AC current cycle is well underway. If the knob is turned the other way, the variable resistor offers less resistance and the capacitor produces the necessary boost voltage earlier in the fluctuating cycle. When the current fluctuates back to the zero voltage point, there is nothing driving current through the triac, so the electrons stop moving. The depletion zones form again, and the triac loses its conductivity until the boost voltage builds up on the gate.

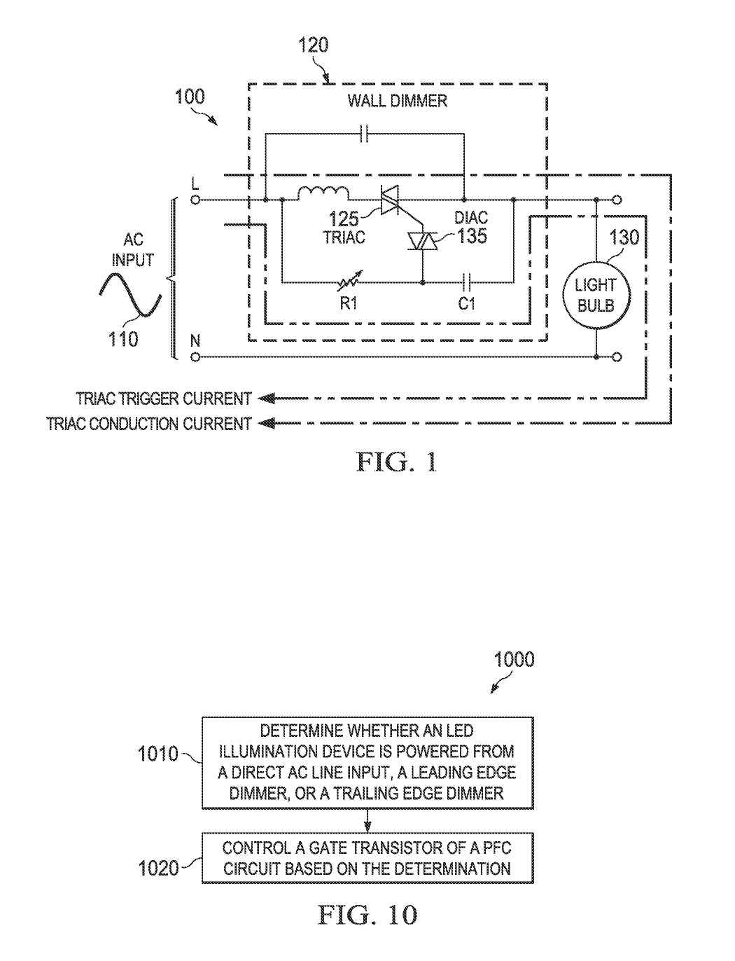

Modern LED lights do not work inherently with existing lighting infrastructure, such as dimmers. LEDs typically do not draw enough power to keep existing dimmers conducting, causing erratic behavior. If an LED illumination device that was not designed to work with a triac dimmer is plugged it into a triac-based dimmer, little, if any, light would be emitted from it, depending on the dimmer setting and the design of that dimmer. More often than not, the LEDs would flash repeatedly, mainly because the LED is not drawing enough power to keep the triac element of the dimmer conducting continuously. As provided in circuit 100 of FIG. 1, the triac based dimmer can be modeled with an RC circuit in the device. Wall dimmer 120 connected to light bulb 130 includes triac 125 and diac 135. At the start of the AC cycle triac 125 is in a non-conducting state. C1 then charges through R1 and light bulb 130. When the voltage on C1 exceeds the threshold voltage of diac 135, for example 20 volts, diac 135 is triggered to dump energy into the controlling gate of triac 125, which may be considered as an SCR latch, to turn it on. R1, which may be variable in the dimmer application, controls when triac 125 turns on, enabling the dimming function.

Once triac 125 turns on, it needs a certain amount of current to continually flow through it to remain in a conduction mode, for example 50 milliamps. Otherwise, triac 125 shuts off. The load from light bulb 130 maintains the holding current of triac 125. Triac 125 turns off close to the zero crossing of the AC input and the cycle repeats.

A challenge for LED luminaries is to first draw some reasonable level of current which looks like a low impedance to AC line input 110 to get the voltage on C1 to charge up to 20 volts at first. Once triac 125 is turned on, the LED luminare typically does not draw enough current to keep triac 125 conducting, thus shutting off triac 125. This challenge may be solved with extra circuitry or energy storage.

Other solutions have presented a low impedance to the line to trigger the triac and stored energy in a capacitor before the triac shuts off. These previous solutions may solve the challenges that the triac presents to an LED luminare, but when connected directly to an AC source, these circuits result in very low power factor. Additionally, these solutions may satisfy triac based dimmers, but they do not always work well with trailing edge dimmers. Another approach is to manipulate the system by wasting energy. Energy may be wasted by drawing excess current in an attempt to keep the triac in a conducting state. This achieves higher power factor but at the cost of efficiency. The disclosed systems and methods of LED dimmer compatibility offer LED systems that fit in applications regardless of whether a dimmer is present or the type of dimmer switch that is used. These disclosed systems and methods provide high power factor without wasting energy.

Not all dimmers are the same. (leading edge versus trailing edge dimmers). Different methods may be used in some applications to satisfy the current requirements of different dimmers. New regulations require LED lights to meet certain PF standard when directly connected to the AC grid (no dimmer). Most circuits to date need to waste power to achieve good PF and work with most dimmers. There are at least three types of wave forms that the LED illumination device may see. A compatibility circuit supply may be integrated into the LED illumination device such that the device may be screwed into any existing light socket. The device may be usable in a socket whether or not a dimmer is on the line. If a dimmer is present, it may be a trailing edge dimmer or a leading edge dimmer. If no dimmer is present on the line, the LED illumination device receives a direct AC line input. With no dimmer, the AC input rises slow and falls slow. However, with the trailing edge dimmer, the AC signal rises slowly and falls quickly when properly triggered. With a leading edge dimmer, the AC signal rises quickly and falls slowly when properly triggered.

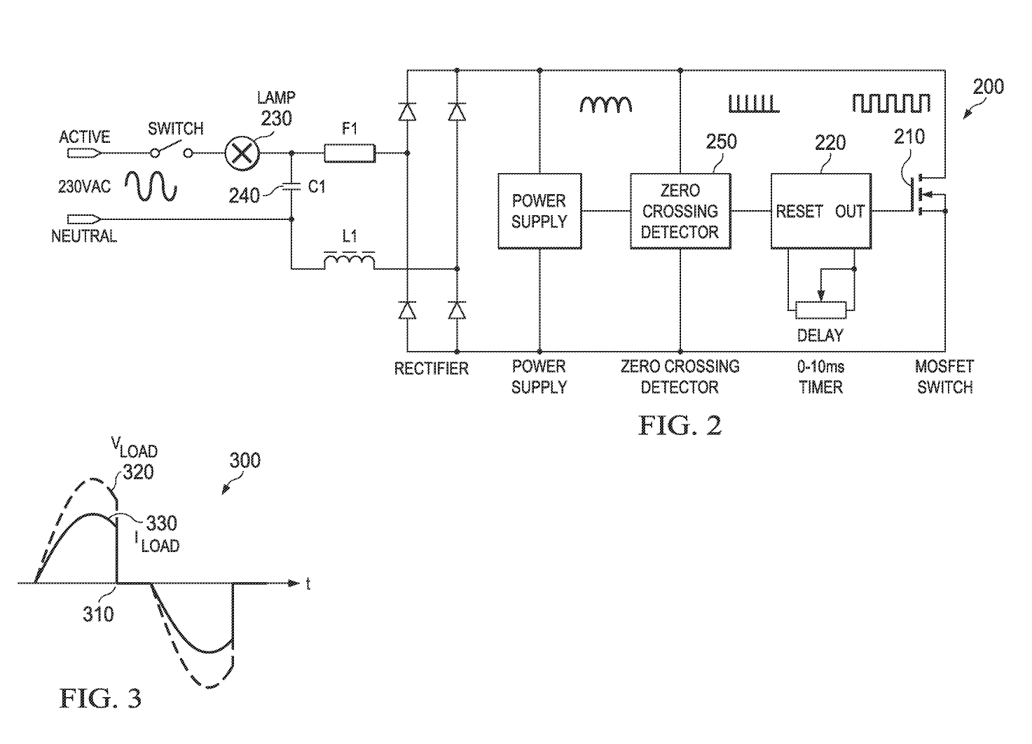

Trailing edge dimmers, an example of which is provided in FIG. 2 provide particular issues. Trailing edge dimmer circuit 200 includes switch 210, delay circuit 220, zero crossing detector 250, light bulb 230, and capacitor 240. Non-limiting examples of switch 210 are a MOSFET and an IGBT. Trailing edge dimmers traditionally do not use triacs, instead comprising other transitional electronic components. At the start of an AC cycle (shown in FIG. 3), switch 210 is in a conducting state. Delay circuit 220 turns switch 210 off part way through the AC line cycle, for example at time 310. The load current from light bulb 230 discharges capacitor 240 after switch 210 turns off. Zero crossing detector 250 resets switch 210 and the cycle repeats. As provided above, LED illumination devices do not always consume enough power to discharge capacitor 240.

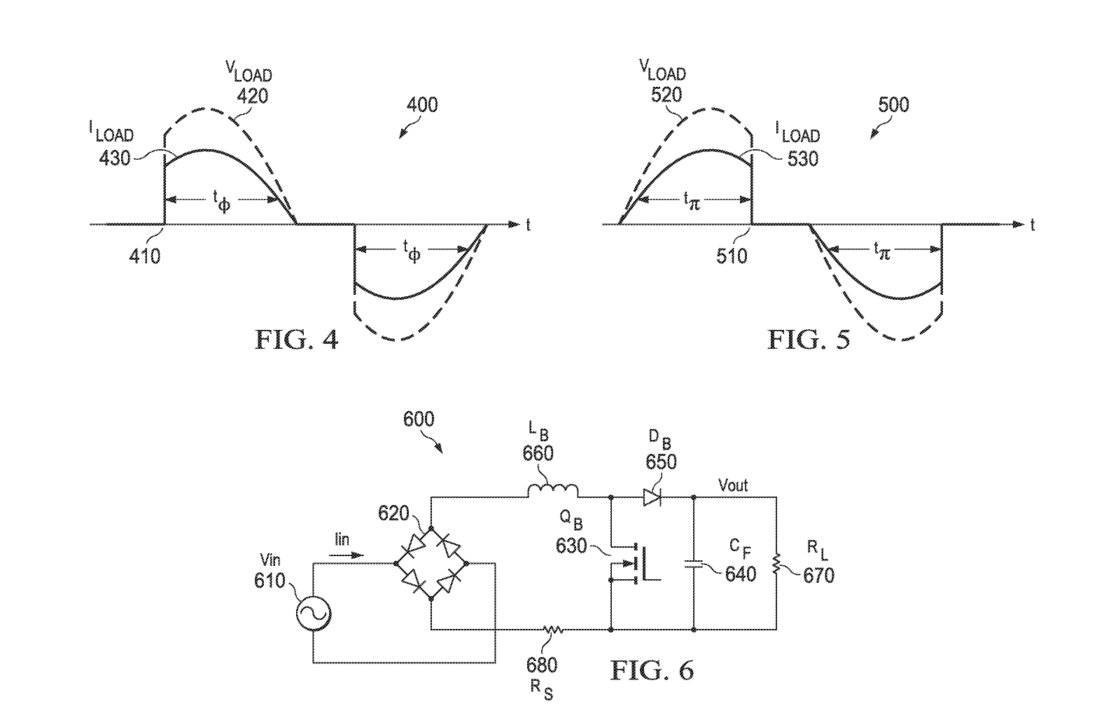

Differences between leading edge dimming and trailing edge dimming are shown in FIG. 4 and FIG. 5 respectively. As shown in signal diagram 400 of FIG. 4, in leading edge dimming, the early part of each sine half wave is chopped off. Leading edge dimmers are suitable for resistive loads such as ordinary incandescent lamps, high voltage halogen lamps, etc.) and inductive loads such as coils, low voltage halogen lamps with conventional transformer, etc. As shown in signal diagram 500 of FIG. 5, in falling edge dimming, the latter part of each sine half wave is chopped off. Failing edge dimmers are suitable for resistive loads and capacitive loads such as low-voltage halogen lamps, transformers, or primary dimming electronic ballasts.

Leading and trailing edge dimmers are examples of phase angle based dimming. The brightness of the illumination is proportional to the dimmer conduction phase angle (t_{φ} in FIG. 4 and t_{π} in FIG. 5). Maximum light is achieved at the highest conduction angles. Phase angle based dimming offers enhanced rejection to AC line voltage variations compared to alternative RMS voltage based dimming techniques.

LED applications are required to have some level of PFC, when directly connected to an AC line. The PFC may be quantified by:

PF=Real Power(W)/Apparent Power(VA)

Recent Energy Star regulations in the United States specify power factor of no less than 0.7 for residential applications and 0.9 for commercial applications. Worldwide requirements increasingly specify power factor limits and in some cases, THD limits (EN61000-3-2 Class C, >25 W). PFC may be provided when a direct AC connection is determined to be present and not provided when there is a dimmer because operation of the dimmer counteracts the gains provided by the PFC. With a boost PFC, for example, near unity power factor may be achieved on the front end. Although boost PFC circuits are primarily referred to in this disclosure, other topologies such as flyback, buck, and forward among others may be used.

An example embodiment of boost PFC circuit 600 is provided in FIG. 6. Circuit 600 comprises power supply 610, rectifier 620, switch 630, boost capacitor 640, boost diode 650, boost inductor 660, load resistance 670, and sense resistor 680. Boost PFC circuit 600 works by forcing the input current to follow the input voltage. The output voltage will be greater than the peak line voltage. A shorted output cannot be protected by controlling the boost switch. Boost PFC circuit 600 may be used, for example, in multistage wide input range converters. Boost PFC circuit 600 may be used in one of three principle modes of operation: continuous conduction mode (CCM), discontinuous conduction mode (DCM), and transition or critical conduction mode (CRM).

In circuit 600, diode bridge or rectifier 620 rectifies AC input voltage 610 ahead of inductor 660. The output of the boost regulator is a constant voltage but the input current is programmed by the input voltage to be a half sine wave. The power flow into output capacitor 640 is not constant but is a sine wave at twice the line frequency since power is the instantaneous product of voltage and current. Output capacitor 640 stores energy when the input voltage is high and releases the energy when the input voltage is low to maintain the output power flow. The disclosed systems and methods of LED illumination compatibility are applicable in both isolated and non-isolated applications.

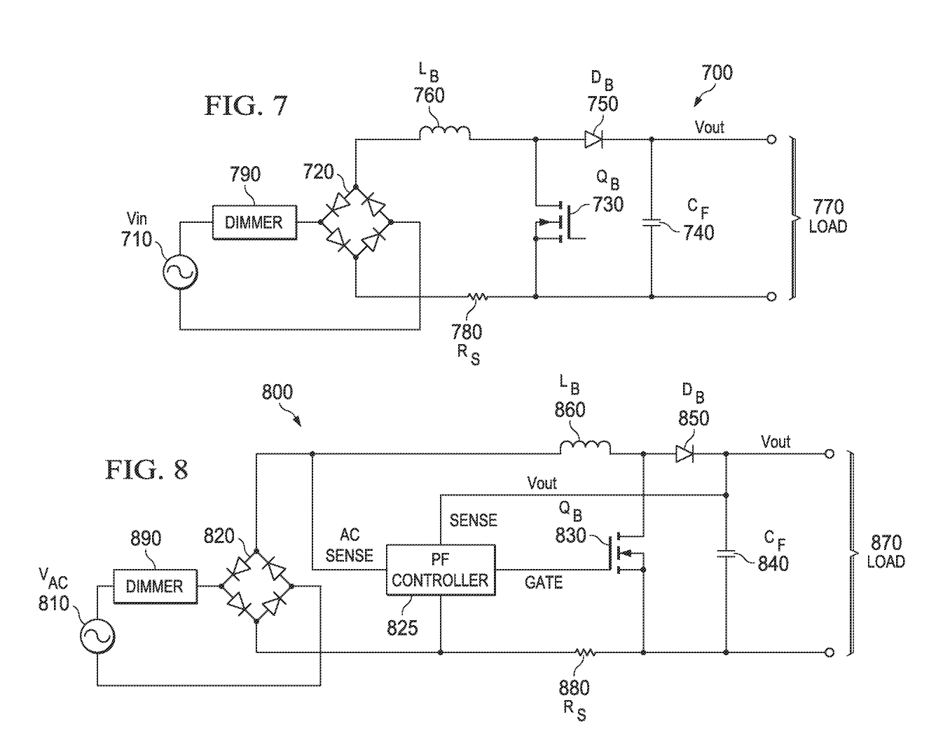

FIG. 7 provides an example embodiment of circuit 700 of a boost PFC circuit with dimmer 790. Circuit 700 comprises power supply 710, rectifier 720, switch 730, boost capacitor 740, boost diode 750, boost inductor 760, load resistance 770, sense resistor 780, and dimmer 790. If dimmer 790 is not present, in cases in which there is a direct AC connection, the boost PFC circuit may provide near unity PF. If dimmer 790 comprises a trailing edge dimmer, the normal switching action of boost switch 730 will discharge to dimmer capacitor 240 of FIG. 2. If dimmer 790 comprises a leading edge triac dimmer, boost FET 730 may provide a low impedance “triggering” load to the triac. Boost capacitor 740 may provide the energy storage to satisfy the triac holding current. Substantially lossless dimmer control may be achieved as energy used to satisfy the dimmer triac is first transferred to boost capacitor 740 and then delivered to load 770.

Additional intelligence in the LED illumination device is necessary to control the PFC circuit when a leading edge dimmer is detected. Trailing edge dimmer connections may be treated the same as a direct AC connection. The conduction of a trailing edge dimmer is controlled within the dimmer (timer 220 of FIG. 2), thus making it independent of the load. Triac and leading edge dimmers rely on the load to charge up diac 135 of FIG. 1. The discharging of the falling edge voltage in a trailing edge dimmer may be accounted for by the normal operation of the PFC circuit. In addition to treating the trailing edge dimmer connection the same as a direct AC connection, the PFC switch can be kept on during and after the falling edge of the trailing edge is detected. This would save some power loss due to the switching currents of the PFC and ensure a faster discharge of capacitor 240 of FIG. 2. Leading edge dimmers have different characteristics to be managed.

In an example embodiment, a boost PFC staged is applied to a leading edge dimmer. The gate transistor of the boost PFC circuit is held at substantially 100% duty cycle until the triac fires and then transitions to normal PFC operation (switching). After it is determined that sufficient energy has been transferred to the PFC output capacitor, the gate transistor of the boost PFC may be shut off. It is preferable for the PFC stage to run for a short period of time after the triac fires before being shut off to ensure reasonable energy transfer to the boost capacitor. If the PFC gate transistor is left running after the leading edge dimmer shuts off (due to insufficient current), a false triggering of the triac may result. In the example embodiment, the boost PFC circuit triggers the triac, producing a triac conduction angle that is consistent from AC line cycle to AC line cycle so that a leading edge application emulates a trailing edge application. It can be used in both isolated or non-isolated designs.

Using a PFC stage for energy storage allows for the transfer of energy used to trigger the triac to the output capacitor of the PFC and thus into the LED load. This is accomplished because the current used to charge the traic's RC network is stored in the PFC inductor via the 100% duty cycle of the PFC switch. When the TRIAC fires and the PFC stage becomes active (switching), the energy stored in the inductor is subsequently re-directed to the output capacitor. Although this is not a significant amount of power, when used in sub-10 W and 5 W systems, milliwatts of power can have an impact on overall efficiency.

FIG. 8 provides an example embodiment of circuit 800 of a boost PFC circuit with dimmer 890. Circuit 800 comprises power supply 810, rectifier 820, PFC controller 825, switch 830, boost capacitor 840, boost diode 850, boost inductor 860, load resistance 870, sense resistor 880, and dimmer 890. Circuit 800 provides continuous monitoring of the AC input via the AC sense input of PFC controller 825. PFC controller 825 may determine the presence and the type of dimmer. In an example embodiment, two comparators may be used to determine whether the connection to the LED illumination device is a direct AC line, a trailing edge dimmer, or a leading edge dimmer. The two comparators may be used to monitor the rate of rise and rate of fall of the AC input voltage. In a direct AC connection application, the time delay between the rise rate and the fall rate is low, and may be substantially equal—for example, hundreds of microseconds depending on the difference between the two comparator voltage thresholds. In the case of trailing edge versus leading edge, the order of the switching of the output determines whether rising edge switching or falling edge switching is quicker. In a leading edge dimmer, the rise rate is faster than the fall rate. In a falling edge dimmer, the fall rate is faster than the rise rate.

PFC controller 825 may measure the conduction phase angle produced by dimmer 890 and provide intelligent control of PFC gate 830 for dimmer loading. If a direct AC connection is determined, PFC controller 825 may provide traditional PFC operation. If dimmer 890 is determined to be a trailing edge dimmer, PFC controller 825 may turn on switch 830 after trailing edge dimmer 890 is disabled, the disabling performed by asserting switch 210 of FIG. 2 to effectively allow the output voltage of the dimmer to fall to zero. If dimmer 890 is determined to be a leading edge dimmer, PFC controller 825 turns on switch 830 to trigger the triac in dimmer 890 and turns off switch 830 prior to the triac in dimmer 890 stopping conducting.

In the case of a leading edge dimmer, hysteretic regulation of Vₒᵤₜ may also be provided by PFC controller 825. In an example embodiment, an additional hysteretic voltage control loop is integrated with PFC controller 825 to enable the PFC circuit when the output voltage of the PFC stage is below a given threshold. Once the output voltage falls below this threshold, the PFC stage becomes active upon the trigger of the triac and remains active until the PFC output voltage exceeds a higher voltage threshold. The hysteresis loop ensures that a sufficient load is presented to the dimmer to maintain conduction. Selecting the amount of voltage hysteresis on the PFC output ensures proper operation. The greater the voltage differential between the thresholds, the more power required to charge it back to full value. The hysteresis algorithm may cause skipping (PFC remains disabled) of subsequent AC line cycles while the output voltage decays.

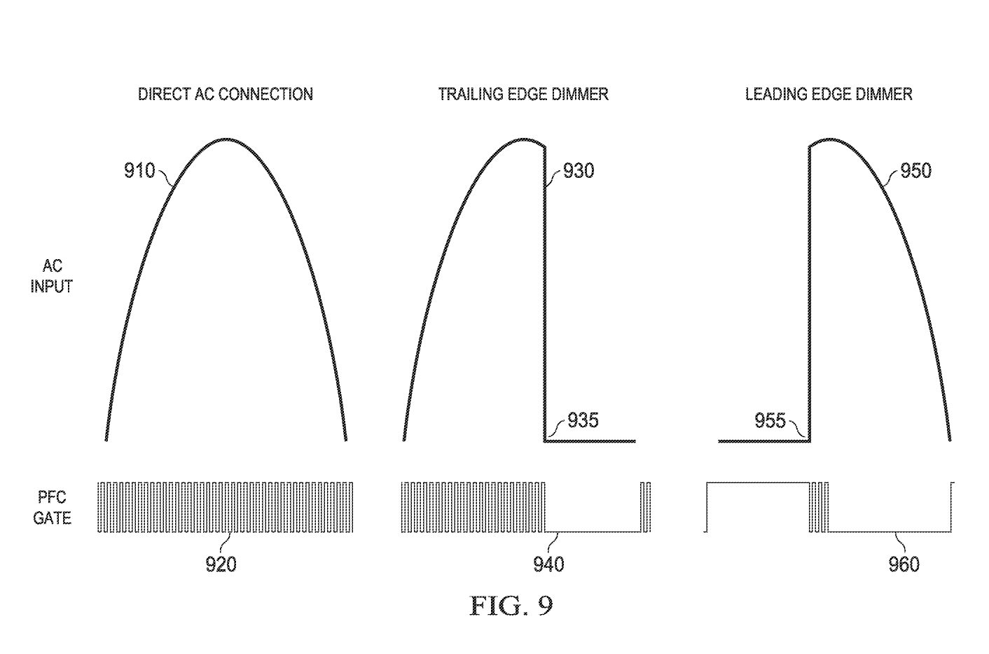

FIG. 9 provides example embodiments of signal diagrams of three connections to the LED illumination device. Signal 910 is a half cycle of a direct AC connection to an LED illumination device. PFC controller 825 controls switch 830 with a signal such as signal 920 to provide high power factor and steady illumination of the LED illumination device. Signal 930 is a half cycle of a trailing edge dimmer connection to an LED illumination device. PFC controller 825 controls switch 830 with a constant switching signal until time 935 when switch 830 is switched off. Once the circuit determines that the voltage has dropped to zero, the PFC stage switching can be halted, shutting off switch 830 until the voltage returns on the next line cycle and switching is resumed. Signal 950 is a half cycle of a leading edge dimmer connection to an LED illumination device. PFC controller 825 controls switch 830 with a 100% duty cycle signal to trigger the triac in the dimmer. When the triac starts conducting at time 955, PFC controller 825 begins switching switch 830 to transfer energy to capacitor 840. PFC controller 825 then goes to 0% duty cycle to ensure detection of the zero crossing of the AC signal. Monitoring of the PFC output voltage or current through the PFC stage may also be used to determine when switch 830 is to be disabled. The PFC stage should not run if the triac shuts back off, which is a high probability under light load/deep dimming conditions. The PFC stage may have a pre-determined amount of charge to replenish the PFC output cap whenever it is enabled by using a hysteretic loop.

FIG. 10 provides flowchart 1000 of a method of LED dimmer compatibility. In block 1010, a determination is made as to whether an LED illumination device is powered from a direct AC line input, a leading edge dimmer, or a trailing edge dimmer. In block 1020, a gate transistor of a PFC circuit is controlled based on the determination of block 1010.

Although the present disclosure has been described in detail, it should be understood that various changes, substitutions and alterations can be made thereto without departing from the spirit and scope of the disclosure as defined by the appended claims.

Therefore, at least the following is claimed:

1. A system for illuminating an light emitting diode (LED) illumination device comprising:
a first comparator configured to monitor a rising time of an alternating current (AC) input to the LED illumination device;
a second comparator configured to monitor the falling time of the AC input to the LED illumination device; and
a power factor correction (PFC) controller connected between the LED illumination device and the AC input, the PFC controller configured to:
determine whether the LED illumination device receives the AC input from a direct AC line, a trailing edge dimmer, or a leading edge dimmer by comparing the timing of the switching of the output of the first comparator and the second comparator; and
control a gate transistor connected to the LED illumination device based on the comparison.

2. The system of claim 1, wherein the LED illumination device is determined to receive a direct AC line input when the rising and falling times of the first comparator and the second comparators are substantially equal.

3. The system of claim 1, wherein the LED illumination device is determined to receive a trailing edge dimmer input when the falling rate is faster than the rising rate.

4. The system of claim 1, wherein the LED illumination device is determined to receive a leading edge dimmer input when the rising rate is faster than the falling rate.

5. The system of claim 1, wherein if the AC input is determined to be from the direct AC line or the trailing edge dimmer, the gate transistor is driven with a continuous pulse width modulation signal.

6. The system of claim 1, wherein if the AC input is determined to be from the leading edge dimmer, the gate transistor is driven with a substantially 100% duty cycle until a triac in the dimmer begins conducting.

7. The system of claim 1, wherein the PFC controller is configured in at least one of a flyback circuit, a boost circuit, and a buck circuit.

8. The system of claim 1, further comprising a hysteretic control loop configured to control the enabling of the PFC controller.

9. A method of illuminating a light emitting diode (LED) illumination device comprising:
determining whether the LED illumination device receives an AC input from a direct AC line, a trailing edge dimmer, or a leading edge dimmer; and
controlling a gate transistor of a power factor correction (PFC) circuit connected to the LED illumination device based on the determination.

10. The method of claim 9, wherein the determining comprises comparing the rise rate and fall rate of the AC input to the LED illumination device.

11. The method of claim 9, wherein the LED illumination device is determined to receive a direct AC line input when the rising and falling times of the first comparator and the second comparators are substantially equal.

12. The method of claim 9, wherein the LED illumination device is determined to receive a trailing edge dimmer input when the falling rate is faster than the rising rate.

13. The method of claim 9, wherein the LED illumination device is determined to receive a leading edge dimmer input when the rising rate is faster than the falling rate.

14. The method of claim 9, further comprising driving the gate transistor with a continuous pulse width modulation signal if the AC input is determined to be from the direct AC line or the trailing edge dimmer.

15. The method of claim 9, further comprising driving the gate transistor with a substantially 100% duty cycle signal until a triac in the dimmer begins conducting if the AC input is determined to be from the leading edge dimmer.

16. A light emitting diode (LED) illumination device comprising:
at least one LED; and
a power factor correction (PFC) controller connected between the LED illumination device and an AC input to the LED illumination device, the PFC controller configured to:
determine whether the LED illumination device receives the AC input from a direct AC line, a trailing edge dimmer, or a leading edge dimmer; and
control a gate transistor connected to the LED illumination device based on the determination.

17. The device of claim 16, further comprising:
a first comparator configured to monitor a rising time of the AC input; and
a second comparator configured to monitor the falling time of the AC input,
wherein the determination by the PFC controller compares the outputs of the first comparator and the second comparator.

18. The device of claim 16, wherein if the AC input is determined to be from the direct AC line or the trailing edge dimmer, the gate transistor is driven with a continuous pulse width modulation signal.

19. The device of claim 16, wherein if the AC input is determined to be from the leading edge dimmer, the gate transistor is driven with a substantially 100% duty cycle until a triac in the dimmer begins conducting.

20. The device of claim 16, wherein the PFC controller is configured in at least one of a flyback circuit, a buck circuit, and a boost circuit.
